(19) United States
(12) Patent Application Publication
(10) Pub. No.: US 2017/0220231 A1
(43) Pub. Date: Aug. 3, 2017

(54) Mobile Terminal, and Mobile Terminal Webpage Window Processing Method and Electronic Device

(71) Applicants: Le Holdings (Beijing) Co., Ltd., Beijing (CN); Lemobile Information Technology (Beijing) Co., Ltd, Beijing (CN)

(72) Inventor: Kaiyue Deng, Beijing (CN)

(21) Appl. No.: 15/241,546

(22) Filed: Aug. 19, 2016

Related U.S. Application Data
(63) Continuation of application No. PCT/CN2016/088780, filed on Jul. 6, 2016.

(30) Foreign Application Priority Data
Feb. 1, 2016 (CN) 201610069673.1

(51) Int. Cl. G06F 3/0484; G06F 3/0482; G06F 3/0488

(52) U.S. Cl. CPC G06F 3/04845; G06F 3/04883; G06F 3/0482

(57) ABSTRACT

A mobile terminal, a mobile terminal webpage window processing method and an electronic device are provided. The method includes the steps: detecting a long-press event, which is used for representing creation of a new webpage window, on a currently displayed webpage window; and generating the new webpage window according to the long-press event. The long-press event is detected on the currently displayed webpage window, and the new webpage window is generated according to the long-press event so that, as compared with the prior art in which the new webpage window is created through a secondary menu, the reachable path for creating a new webpage is shortened and system operation efficiency is increased.

### CROSS REFERENCE TO RELATED APPLICATIONS

This application is a continuation of International Application No.PCT/CN2016/088780, filed on Jul. 6, 2016, which is based upon and claims priority to Chinese Patent Application No. 201610069673.1, filed on Feb. 1, 2016, titled “Mobile Terminal, and Mobile Terminal Webpage Window Processing. Method and Device”, and the entire contents of which are incorporated herein by reference.

### TECHNICAL FIELD

The application relates to the technical field of mobile terminals, and particularly relates to a mobile terminal, a mobile terminal webpage window processing method and an electronic device.

### BACKGROUND

With the rapid development of the electronic product technology and the fast change of the communication technology, mobile terminals, such as intelligent mobile phones, tablet personal computers, etc., have become an indispensable part of people's life. Moreover, with the popularization of these technologies, many users transfer more and more work from PC to the mobile terminals, e.g., browsing webpages, receiving and sending E-mails and using multimedia players through the intelligent mobile phones or tablet personal

When browsing the webpages with the mobile terminals, the users often need to open another webpage window while retaining an originally opened webpage window so as to operate a plurality of webpage windows at the same time. In the prior art, a taskbar in a browser is generally needed to perform operations. For example, when the users need to create a new window, the users can click “+” button in the taskbar, after that, a corresponding secondary menu bar pops up; the users need to choose and click a button for representing adding of a new webpage in the secondary menu bar again for opening a new webpage window; that is, the users need to click the button in the taskbar→the secondary menu→open the webpage when creating the new webpage each time.

With the increasing needs of the users for creating the new webpage, how to shorten the reachable path for creating the new webpage becomes a problem to be urgently solved as the reachable path for creating the new webpage is complicated.

### SUMMARY

The application provides a mobile terminal, a mobile terminal webpage window processing method and an electronic device, which can shorten the reachable path for creating a new webpage and increase system operation efficiency.

One objective of the embodiments of the application is to provide a mobile terminal webpage window processing method, comprising:

detecting a long-press event, which is used for representing creation of a new webpage window, on a currently displayed webpage window; and generating the new webpage window according to die long-press event.

Preferably, the detecting a long-press event, which is used for representing creation of a new webpage window, on a currently displayed webpage window comprises: detecting the long-press event in a current taskbar area.

Preferably, the currently displayed webpage window is covered by the new webpage window.

Preferably, the mobile terminal webpage window processing method further comprises the steps of detecting a slide event on the currently displayed webpage window; and executing an operation mapped to the direction of the slide event according to the direction of the slide event,

Preferably, a mapping relationship between the direction of the slide event and the operation is switching the displayed webpage window in case of sliding along a first direction; and closing the currently displayed webpage window in case of sliding along, a second direction.

Preferably, the switching the displayed webpage window in case of sliding along a first direction comprises switching to a webpage window generated before the current webpage window in case of sliding along a positive direction of the first direction; and switching to a webpage window generated after the current webpage window in ease of sliding along a negative direction of the first direction.

Another objective of the embodiments of the application is to provide a mobile terminal, comprising:

a screen used for displaying a webpage window and receiving a touch event; and a processor used for executing programs to implement the above-mentioned method.

A further objective of the embodiments of the application is to provide an electronic device, comprising: at least one processor; as well as a memory communicably connected with the at least one processor for storing instructions executable by the at least one processor, wherein, execution of the instructions by the at least one processor causes the at least one processor to detect a long-press event, which is used for representing creation of a new webpage window, on a currently displayed webpage window, and generate the new webpage window according to the long-press event.

The electronic device, wherein, the detecting a long-press event, which is used for representing creation of a new webpage window, on a currently displayed webpage window comprises detecting the long-press event in a current taskbar area.

The electronic device, wherein, the currently displayed webpage window is covered by the new webpage window.

The electronic device, wherein, further comprising: detecting, a slide event on the currently displayed webpage window; and executing an operation mapped to the direction of the slide event according to the direction of the slide event.

The electronic device, wherein, a mapping relationship between the direction of the slide event and the operation is switching the displayed webpage window in case of sliding along a first direction; and closing the currently displayed webpage window in case of sliding along a second direction.

The electronic device, wherein, the switching the displayed webpage window in case of sliding along a first direction comprises switching to a webpage window generated before the current webpage window in case of sliding along a positive direction of the first direction; and switching to a webpage window generated after the current webpage window in case of sliding along a negative direction o the first direction.

A further objective of the embodiments of the application is to provide a non-transitory computer-readable storage medium storing computer-executable instructions, execution of the computer-executable instructions by the electronic device causes the electronic device to detect a long-press event, which is used for representing creation of a new webpage window, on a currently displayed webpage window; and generate the new webpage window according to the long-press event.

The non-transitory computer-readable storage medium, wherein, the detecting a long-press event, which is used for representing creation of a new webpage window, on a currently displayed webpage window comprises detecting the long-press event in a current taskbar area.

The non-transitory computer-readable storage medium, wherein, the currently displayed we window is covered by the new webpage window.

The non-transitory computer-readable storage medium, wherein, further comprising: detecting a slide event on the currently displayed webpage window; and executing an operation mapped to the direction of the slide event according to the direction of the slide event.

The non-transitory computer-readable storage medium, wherein, a mapping relationship between the direction of the slide event and the operation is switching the displayed webpage window in case of sliding along a first direction; and closing the currently displayed webpage window in case of sliding along a second direction.

The non-transitory computer-readable storage medium, wherein, the switching the displayed webpage window in case of sliding along a first direction comprises switching to a webpage window generated before the current webpage window in case of sliding along a positive direction of the first direction; and switching to a webpage window generated after the current webpage window in case of sliding along a negative direction of the first direction.

In the webpage window processing method and the electronic device provided in the embodiments of the application, a long-press event is detected on a currently displayed webpage window, and a new webpage window is generated according to the long-press event so that, as compared with the prior art in which the new webpage window is created through a secondary menu, the reachable path for creating a new webpage is shortened and system operation efficiency is increased.

As a preferred technical solution, a slide event is detected on the currently displayed webpage window and an operation mapped to the direction of the slide event is executed, so as to further shorten the reachable path of the operation mapped to the direction of the slide event.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a mobile terminal webpage window processing method in the embodiments of the application.

FIG. 2 is a display diagram of a mobile terminal display screen in the embodiments of the application.

FIG. 3 is a structural diagram of a mobile terminal webpage window processing device in the embodiments of the application.

FIG. 4 is a schematic diagram of the hardware configuration of an electronic device provided by the embodiment, which performs a mobile terminal webpage window processing method.

### DETAILED DESCRIPTION

In order to clearly describe objectives, the technical solutions and advantages of the embodiments of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

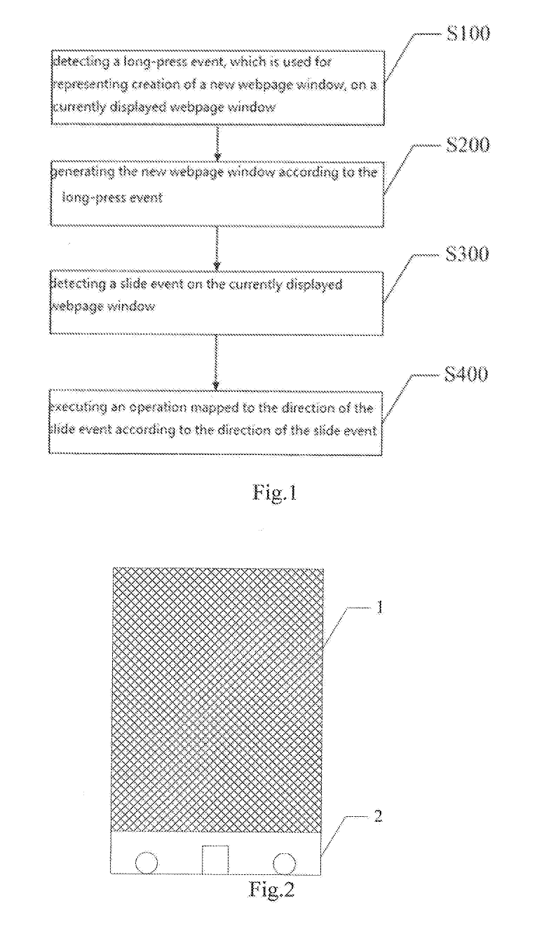

Refer to FIG. 1, which shows a flow chart of a mobile terminal webpage window processing method disclosed in the embodiment of the application. The webpage window processing method comprises the following steps:

In the step S100, a long-press event is detected, which is used for representing creation of a new webpage window, on a currently displayed webpage window; wherein, refer to FIG. 2, which shows a diagram of a mobile terminal display screen, wherein a mesh area is a webpage display area 1, a blank area is a taskbar area 2 and virtual buttons having certain functions are gathered on the taskbar area 2; generally, a touch event in the webpage display area 1 is related to the contents in the currently displayed webpage window; therefore, in the embodiment, the long-press event in the current taskbar area 2 is preferably detected; of course, in other embodiments, the long-press event in the webpage display area 1 can also be detected.

In step S200, the new webpage window is generated according to the long-press event; wherein, in the embodiment, after the long-press event is detected on the currently displayed webpage window, the new webpage window can be generated according to the long-press event; and preferably, the currently displayed webpage window is covered by the new webpage window.

In a preferred embodiment, the webpage window processing method comprises the following steps:

In step S300, a slide event on the currently displayed webpage window is detected; wherein, in the embodiment, the slide event comprises a slide action and a direction of the slide action.

In step S400, an operation mapped to the direction of the slide event is executed according to the direction of the slide event; wherein, in a specific embodiment, a corresponding operation can be mapped to the direction of the slide event and stored in advance, and when the corresponding direction of slide time is detected, the operation mapped to the direction of the slide event is executed; specifically, a mapping relationship between the direction of the slide event and the operation is: switching the displayed webpage window in case of sliding along a first direction; and closing the currently displayed webpage window in case of sliding along a second direction; in the embodiment, the first direction can be a left and right direction relative to the webpage window, and the second direction can be an up and down direction relative to the webpage window.

In a preferred embodiment, in the operation of switching the displayed webpage window in case of sliding along the first direction: switching to a webpage window generated before the current webpage window in case of sliding along a positive direction of the first direction; and switching to a webpage window generated after the current webpage window in case of sliding along a negative direction of the first direction. When the first direction is the left and right direction relative to the webpage window, the so-called positive direction can be a right direction and then the negative direction can be a left direction. Of course, the so-called positive direction can also be the left direction, and then the negative direction is the right direction.

### Embodiment 2

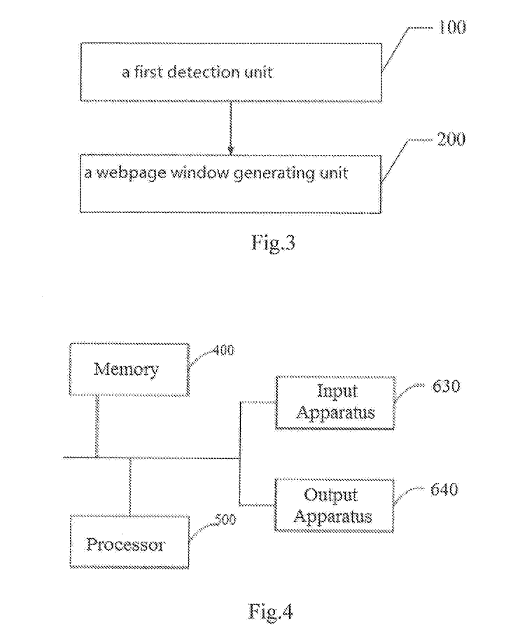

The embodiment discloses a mobile terminal webpage window processing device. Refer to FIG. 3. The mobile terminal webpage window processing device comprises: a first detection unit 100 and a webpage window generating unit 200, wherein:

the first detection unit 100 is used for detecting a long-press event, which is used for representing creation of a new webpage window, on a currently displayed webpage window; and the webpage window generating unit 200 is used for generating the new webpage window according to the long-press event. In a preferred embodiment, the currently displayed webpage window is covered by the new webpage window.

In a preferred embodiment, the mobile terminal webpage window processing device further comprises; a second detection unit and an operation unit, wherein: the second detection unit is used for detecting a slide event on the currently displayed webpage window; and the operation unit is used for executing an operation mapped to the direction of the slide event according to the direction of the slide event.

### Embodiment 3

The embodiment further discloses a mobile terminal which comprises: a screen and a processor, wherein, the screen is used for displaying a webpage window and receiving a touch event; and the processor is used for executing programs to implement the mobile terminal webpage window processing method disclosed in the above-mentioned embodiments.

In the webpage window processing method and device disclosed in the embodiments, the long-press event is detected on the currently displayed webpage window, and the new webpage window is generated according to the long-press event so that, as compared with the prior art in which the webpage window is created through a secondary menu, the reachable path for creating a new webpage is shortened and system operation efficiency is increased.

In a preferred embodiment, a slide event is detected on the currently displayed webpage window and an operation mapped to the direction of the slide event is executed, so as to further shorten the reachable path of the operation mapped to the direction of the slide event.

### Embodiment 4

The embodiment of the application further provides a non-transitory computer-readable storage medium storing computer-executable instructions, and the computer-executable instructions can execute a mobile terminal webpage window processing method in any one above-mentioned method embodiments.

Computer-executable instructions are stored in the non-transitory computer-readable storage medium, and execution of the computer-executable instructions by the electronic device causes the electronic device to detect a long-press event, which is used for representing creation of a new webpage window, on a currently displayed webpage window; and generate the new webpage window according to the long-press event.

The non-transitory computer-readable storage medium, wherein, the detecting a long-press event, which is used for representing creation of a new webpage window, on a currently displayed webpage window comprises detecting the long-press event in a current taskbar area.

The non-transitory computer-readable storage medium, wherein, the currently displayed webpage window is covered by the new webpage window.

The non-transitory computer-readable storage medium, wherein, further comprising: detecting a slide event on the currently displayed webpage window; and executing an operation mapped to the direction of the slide event according to the direction of the slide event.

The non-transitory computer-readable storage medium, wherein, a mapping relationship between the direction of the slide event and the operation is switching the displayed webpage window in case of sliding along a first direction; and closing the currently displayed webpage window in case of sliding along a second direction.

The non-transitory computer-readable storage medium, wherein, the switching the displayed webpage window in case of sliding along a first direction comprises switching to a webpage window generated before the current webpage window in case of sliding along a positive direction of the first direction; and switching to a webpage window generated after the current webpage window in case of sliding along a negative direction of the first direction.

### Embodiment 5

The embodiments of the application further provide an electronic device for executing a mobile terminal webpage window processing, method, comprising at least one processor as well as a memory communicably connected with the at least one processor for storing instructions executable by the at least one processor, wherein, execution of the instructions by the at least one processor causes the at least one processor to detect a long-press event, which is used for representing creation of a new webpage window, on a currently displayed webpage window, and generate the new webpage window according to the long-press event.

The electronic device, wherein, the detecting a long-press event, which is used, for representing creation of anew webpage window, on a currently displayed webpage window comprises detecting the long-press event in a current taskbar area.

The electronic device, wherein, the currently displayed webpage window is covered by the new webpage window.

The electronic device, wherein, further comprises detecting a slide event en the currently displayed webpage window; and executing an operation mapped to the direction of the slide event according to the direction of the slide event.

The electronic device, wherein, a mapping relationship between the direction of the slide event and the operation is switching the displayed webpage window in case of sliding along a first direction; and closing the currently displayed webpage window in case of sliding along a second direction.

The electronic device, wherein, the switching the displayed webpage window in case of sliding along a first direction comprises switching to a webpage window generated before the current webpage window in case of sliding along a positive direction of the first direction; and switching to a webpage window generated after the current webpage window in case of sliding along a negative direction of the first direction.

### Embodiment 6

FIG. 4 is a schematic diagram of the hardware configuration of the electronic device provided by the embodiment, which performs a mobile terminal webpage window processing method. As shown in FIG. 4, the electronic device includes: one or more processors 500 and a memory 400, wherein one processor 500 is shown in FIG. 4 as an example. The electronic device that performs a multi-media photo generating method further includes an input apparatus 630 and an output apparatus 640.

The processor 500, the memory 400, the input apparatus 630 and the output apparatus 640 may be connected via a bus line or other means, wherein connection via a bus line is shown in FIG. 4 as an example.

The memory 400 is a non-transitory computer-readable storage medium that can be used to store non-transitory software programs, non-transitory computer-executable programs and modules, such as the program instructions/modules corresponding to the mobile terminal webpage window processing method of the embodiments of the application (e.g. a first detection unit 100 and a webpage window generating unit 200 shown in FIG. 3). The processor 500 executes the non-transitory software programs, instructions and modules stored in the memory 400 so as to perform various function application and data processing of the server, thereby implementing the mobile terminal webpage window processing method of the above-mentioned method embodiments.

The memory 400 includes a program storage area and a data storage area, wherein, the program storage area can store an operation system and application programs required for at least one function; the data storage area can store data generated by use of a multi-media photo generating device. Furthermore, the memory 400 may include a high-speed random access memory, and may also include a non-volatile memory, e.g. at least one magnetic disk memory unit, flash memory unit, or other non-volatile solid-state memory unit. In some embodiments, optionally, the memory 400 includes a remote memory accessed by the processor 500, and the remote memory is connected to a mobile terminal webpage processing device via network connection. Examples of the aforementioned network include but not limited to Internet, intranet, LAN, GSM, and their combinations.

The input apparatus 630 receives digit or character information, so as to generate signal input related to the user configuration and function control of a mobile terminal webpage window processing device. The output apparatus 640 includes display devices such as a display screen.

The one or more modules are stored in the memory 400 and, when executed by the one or more processors 500, perform the mobile terminal webpage window processing method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should he noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is;:

1. A mobile terminal webpage window processing method, comprising the following steps:
detecting a long-press event, which is used for representing creation of a new webpage window, on a currently displayed webpage window; and
generating the new webpage window according to the long-press event.

2. The mobile terminal webpage window processing method of claim 1, wherein, the detecting a long-press event, which is used for representing creation of a new webpage window, on a currently displayed webpage window, comprising: detecting the long-press event in a current taskbar area,

3. The mobile terminal web-page window processing method of claim 1, wherein, the currently displayed webpage window is covered by the new webpage window.

4. The mobile terminal webpage window processing method of claim 1, wherein, further comprising the steps:
detecting a slide event on the currently displayed webpage window; and
executing an operation mapped to the direction of the slide event according to the direction of the slide event.

5. The mobile terminal webpage window processing method of claim 4, wherein, a mapping relationship between the direction of the slide event and the operation is:
switching the displayed webpage window in case of sliding along a first direction; and
closing the currently displayed webpage window in case of sliding along a second direction.

6. The mobile terminal webpage window processing method of claim 5, wherein, the switching the displayed webpage window in case of sliding along a first direction comprises:
switching to a webpage window generated before the current webpage window in case of sliding along a positive direction of the first direction; and
switching to a webpage window generated after the current webpage window in case of sliding along a negative direction of the first direction.

7. An electronic device, comprising:
at least one processor; and
a memory communicably connected with the at least one processor for storing instructions executable by the at least one processor, wherein, execution of the instructions by the at least one processor causes the at least one processor to:
detect a long-press event, which is used for representing creation of a new webpage window, on a currently displayed webpage window; and
generate the new webpage window according to the long-press event.

8. The electronic device of claim 7, wherein, the detecting a long-press event, which is used for representing creation of a new webpage window, on a currently displayed webpage window, comprising: detecting the long-press event in a current taskbar area.

9. The electronic device of claim 7, wherein, the currently displayed webpage window is covered by the new webpage window.

10. The electronic device of claim 7, wherein, further comprising: detecting a slide event on the currently displayed webpage window; and executing an operation mapped to the direction of the slide event according to the direction of the slide event.

11. The electronic device of claim 10, wherein, a mapping relationship between the direction of the slide event and the operation is: switching the displayed webpage window in case of sliding along a first direction; and closing the currently displayed webpage window in case of sliding along a second direction.

12. The electronic device of claim 11, wherein, the switching the displayed webpage window in case of sliding along a first direction comprises: switching to a webpage window generated before the current webpage window in case of sliding along a positive direction of the first direction; and switching to a webpage window generated after the current webpage window in case of sliding along a negative direction of the first direction.

13. A non-transitory computer-readable storage medium storing executable instructions that, when executed by an electronic device, causes the electronic device to:
detect a long-press event, which is used for representing creation of a new webpage window, on a currently displayed webpage window; and
generate the new webpage window according to the long-press event.

14. The non-transitory computer-readable storage medium of claim 13, wherein, the detecting a long-press event, which is used for representing creation of a new webpage window, on a currently displayed webpage window, comprising: detecting the long-press event in a current taskbar area.

15. The non-transitory computer-readable storage medium of claim 14, wherein, the currently displayed webpage window is covered by the new webpage window.

16. The non-transitory computer-readable storage medium of claim 15, wherein, further comprising: detecting a slide event on the currently displayed webpage window; and executing an operation mapped to the direction of the slide event according to the direction of the slide event.

17. The non-transitory computer-readable storage medium of claim 16, wherein, a mapping relationship between the direction of the slide event and the operation is: switching the displayed webpage window in case of sliding along a first direction; and closing the currently displayed webpage window in case of sliding along a second direction.

18. The non-transitory computer-readable storage medium of claim 17, wherein, the switching the displayed webpage window in case of sliding along a first direction comprises: switching to a webpage window generated before the current webpage window in case of sliding along a positive direction of the first direction; and switching to a webpage window generated after the current webpage window in case of sliding along a negative direction of the first direction.
